(19) United States
(12) Patent Application Publication
(10) Pub. No.: US 2005/0005000 A1
(43) Pub. Date: Jan. 6, 2005

(54) System and method for distributing digital contents, and an edge server

(75) Inventor: Masuo Yoshimoto, Tokyo (JP)

Correspondence Address: OBLON, SPIVAK, MCCLELLAND, MAIER & NEUSTADT, P.C., 1940 DUKE STREET, ALEXANDRIA, VA, 22314, US

(73) Assignees: Ryuzo NAKAZUMI, Tokyo (JP); Masuo YOSHIMOTO, Tokyo (JP)

(21) Appl. No.: 10/614,836

(22) Filed: Jul. 9, 2003

(30) Foreign Application Priority Data
Feb. 14, 2003 (JP) 2003-037345

(51) Int. Cl. G06F 15/177

(52) U.S. Cl. 709/220

(57) ABSTRACT

A system for distributing digital contents over electronic network, the system includes: one or more management PCs configured to collect the digital contents and upload the collected digital contents to FTP servers; and one or more edge servers configured to download the digital contents in advance from the FTP servers, according to instructions from the management PC and deliver the downloaded digital contents to user terminals located in the same network as the edge server according to request from the user terminal.

### BACKGROUND OF THE INVENTION

1. Field of the Invention

The present invention pertains to a system and a method for distributing digital contents, such as video, pictures, sounds, text, and computer programs, over electronic network, and pertains to edge server(s) used in the digital contents distribution system.

2. Description of the Related Art

Delivering and downloading digital contents, such as high-quality videos and audio, has been attained with the widespread use of broadband Internet. However, as the number of users grows, it becomes difficult to serve stable delivery of streaming digital contents to users or downloading by users at high-speed due to heavy load on servers at digital contents providers and at transmission paths.

Thus, Japanese Patent Laid Open Publication (Kokai) No. 2002-215498 discloses technology aiming at a stable supply and high-speed response delivery service for digital contents.

According to the technology disclosed in the above reference, when delivery of digital contents is requested by a user terminal, the digital contents requested by the user are transmitted to the edge node nearest the user terminal from a center node storing the digital contents, and then the digital contents are delivered to the user terminal from the edge node. Therefore, it is possible to distribute the digital contents stably and economically. Moreover, the digital contents cached into the edge node are delivered to the user terminal directly from the edge node in response to the request from the user terminal.

According to the technology disclosed in the above reference, however, if the digital contents requested from the user terminal are not cached in the edge node at the time of the delivery request, it is necessary to distribute relevant digital contents to the edge node from the center node storing the digital contents, which considerable time is required for transmission from the center node to the edge node. Consequently, more time is required to deliver the digital contents to the user terminal, and the user is not able to view and listen to the requested digital contents immediately.

Therefore, where even a slight delay is not allowed that digital contents must be delivered immediately in response to the request by the user, for example, user terminals for customers located in music retail stores, the technology disclosed in the above reference is not enough.

### SUMMARY OF THE INVENTION

A system for distributing digital contents over electronic network according to an embodiment of the present invention includes: (a) One or more management PCs configured to collect the digital contents and upload the collected digital contents to FTP servers; and (b) One more or edge servers configured to download the digital contents in advance from the FTP servers according to instructions from the management PC and deliver the downloaded digital contents to user terminals located in the same network as the edge server upon receipt of a request from the user terminal.

Further, a method for distributing digital contents over electronic network according to an embodiment of the present invention includes: (a) collecting digital contents in a management PC and uploading the collected digital contents from the management PC to FTP servers; (b) downloading digital contents in advance from the FTP server(s) to each edge server according to instructions from the management PC; and (c) delivering the downloaded digital contents to user terminal(s) from the edge server located in the same network as the user terminal upon receipt of a request from the user terminal.

### BRIEF DESCRIPTION OF THE DRAWINGS

FIG. 1 shows an example of a system configuration for distributing digital contents according to an embodiment of the present invention.

FIG. 2 shows an example of a server configuration of an edge server in the digital contents distribution system shown in FIG. 1.

FIG. 3 shows an example of a software structure of a management PC and an edge server in the digital contents distribution system shown in FIG. 1.

FIG. 4 shows basic communication mechanism between a management PC and an edge server in the digital contents distribution system shown in FIG. 1.

FIG. 5 shows an example of functions of the digital contents distribution system shown in FIG. 1.

FIG. 6 shows the process of edge server downloading the digital contents uploaded, from a management PC to FTP server.

FIG. 7 shows the process of edge server extracting digital contents downloaded from the FTP server.

FIG. 8 shows the process of edge server installing digital contents extracted.

FIG. 9 shows the process of edge server deleting digital contents installed.

FIG. 10 shows the process of management PC obtaining, log files from an edge server.

FIG. 11 shows the process of management PC updating the set-up values in an edge server.

FIG. 12 shows the process of management PC deleting files from an edge server.

FIG. 13 shows the process of management PC obtaining the running status of an edge server.

FIG. 14 shows an example of a configuration system for distributing digital contents according to another embodiment of the present invention.

### DETAILED DESCRIPTION

The present invention aims to provide a system and a method for distributing digital contents, which makes it possible to deliver the various digital contents requested by the user terminal over electronic network immediately. Further, the present invention aims to provide edge server used in the digital contents distribution system.

A system for distributing digital contents over electronic network according to an embodiment of the present inventions includes: (a) One or more management PCs configured to collect the digital contents and upload the collected digital contents to FTP servers; and (b) One or more edge servers configured to download the digital contents in advance from FTP servers according to instructions from the management PC and deliver the downloaded digital contents to user terminals located in the same network as the edge server upon receipt of a request from the user terminal.

Further, a method for distributing digital contents over electronic network according to another embodiment of the present inventions including the following stages: (a) collecting the digital contents by a management PC and uploading the collected digital contents from the management PC to FTP server(s); (b) downloading the digital contents in advance from the FTP server(s) to each edge server according to instructions from the management PC; and (c) delivering the downloaded digital contents to user terminal(s) from the edge server located in the same network as the user terminal upon receipt of a request from the user terminal.

In other word, an edge server, located in the same network as a user terminal, downloads the digital contents in advance from the FTP server according to instructions from the management PC. Then, the edge server delivers the downloaded digital contents to the user terminal located in the same network upon receipt of a request from the user terminal. Thus, the request from the user terminal is sent; to the edge server in the same network as the user terminal, and the requested digital contents stored in the edge server can be delivered to the user terminal immediately.

Further, the edge server can be configured to be informed by the management PC of the least loaded FTP server, and to download the digital contents from this specific FTP server where plural FTP servers are deployed.

Furthermore, the edge server can be configured to install, delete or update the contents for streaming delivery into VoD server(s) and to database of the edge server according to an instruction note, and report the result of execution to the management PC, when downloaded digital contents consist of contents for streaming delivery and the instruction note.

Moreover, the edge server can be configured to make the least loaded VoD server deliver the contents to user terminal(s) where plural VoD servers are deployed.

Further, the edge server can be configured to collect logs of delivery to user terminals and upload the collected logs to the FTP server specified by the management PC, the management PC can then download the logs from the FTP server and manage them.

Furthermore, the edge server can be configured to generate Web pages according to the attributes of the user with information stored in the database, and provide the Web pages to the user terminal.

The details of the present invention are described herein below with sample implementation form and reference to the accompanying drawings. It is to be noted that the same or similar reference numerals are applied to the same or similar parts and elements throughout the drawings, and the description of the same or similar parts and elements will be omitted or simplified.

[Configuration of Digital Contents Distribution System]

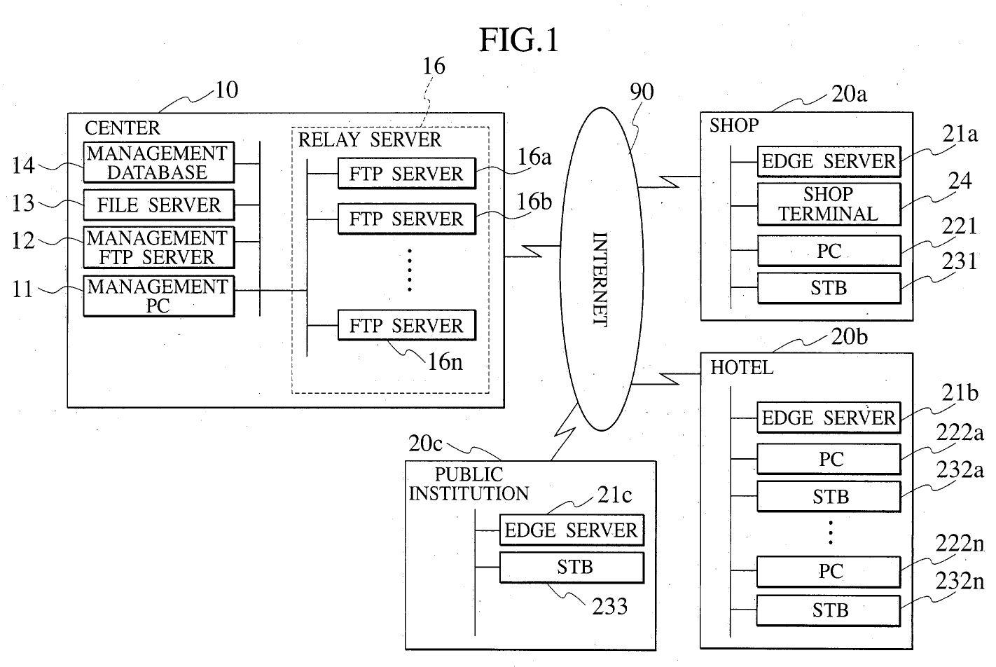

As shown in FIG. 1, a system for distributing digital contents according to the present embodiment distributes digital contents, such as video, pictures, sounds, text, computer programs or the like, over Internet 90 (Asymmetric Digital Subscriber Line (ADSL), Fiber To The Home (FTTH), etc.) or over closed network to shop 20a, hotel 20b, public facility 20c or the like, from an operations center 10.

Management personal computer (PC) 11, management FTP server 12, file server 13, and management database 14 are deployed in the operations center 10, and one or more FTP server 16a, . . . , 16n are deployed as relay server 16 in the same network.

The management PC 11 collects various digital contents, uploads digital contents managed by the file server 13 to FTP servers 16a, . . . , 16n via the management FTP server 12.

On the other hand, edge servers 21a, 21b, and 21c are deployed in the shop 20a, hotel 20b, and public facility 20c respectively. The edge server 21a, shop terminal 24, personal computer (PC) 221 and Set Top Box (STB) 231 are located in the stop 20a and connected to Internet 90. Likewise, the edge server 21b connected to Internet 90 is deployed in the hotel 20b, and PCs 222a, . . . , 222n and STBs 232a, . . . , 232n are in each room at the hotel 20b and connected to Internet 90. The edge server 21c and STB 233 are deployed in the public facility 20c and connected to Internet 90.

Each edge server 21a, 21b, and 21c downloads digital contents in advance from the FTP servers 16a, . . . , 16n according to instruction from the management PC 11 at the operations center 10, and delivers the downloaded digital contents to user terminals (PC 221, 222a, . . . , 222n, STB 231, 233, shop terminal 24 or the like) upon receipt of the request for delivery or download from the user terminal in the same network.

That is, each edge servers 21a, 21b, and 21c is deployed in the same network as respective user terminal (PC 221, PC 222, . . . , 222n, STB 231 and STB 233, shop terminal 24), and downloads digital contents from FTP servers 16a, . . . , 16n in advance according to instruction from the management PC 11 at the operations center 10. Then the edge servers 21a, 21b, and 21c delivers the downloaded digital contents to the user terminals (PC 221, PC 222, . . . , 222n, STB 231 and STB 233, shop terminal 24) upon receipt of the request for delivery or for download from the user terminal located in the same network. In other words, for example, since the request from the PC 221 is sent to the edge server 21a located in the same network as the PC 221, the digital contents stored in the edge server 21a can be delivered immediately to the PC 221.

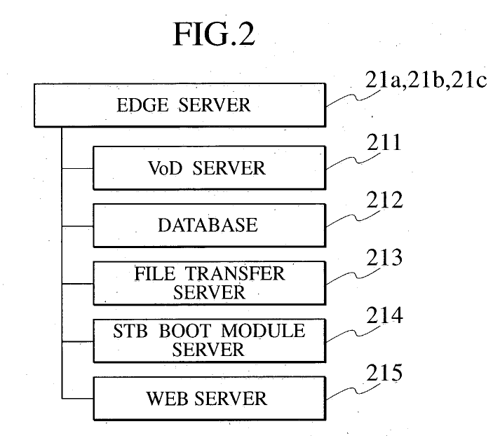

In addition, as shown in FIG. 2, the each edge server 21a, 21b, and 21c contains server components, such as Video on Demand (VOD) server 211, database 212, file transfers server 213, STB boot module server 214 and Web server 215.

[Software Modules of Digital Contents Distribution System]

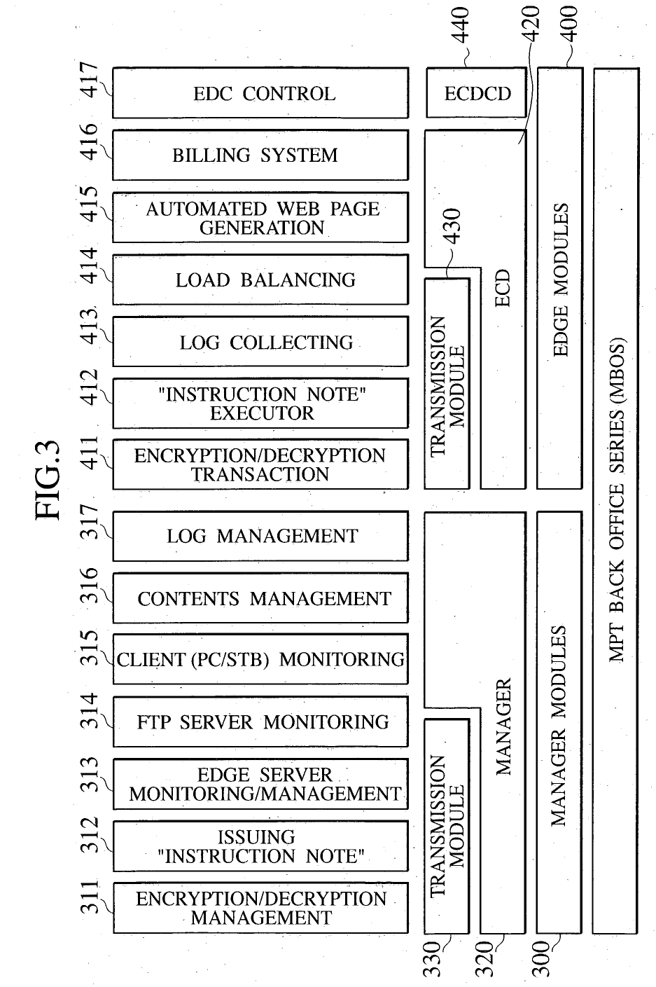

FIG. 3 shows an example of a software structure of the management PC 11 and the edge server 21a, 21b, and 21c in the digital contents delivery system shown in FIG. 1.

The software installed in the management PC 11 includes Manager Modules 300, having Manager 320, main management module, and Transmission Module 330. Manager modules 300 can fulfill functions such as, encryption/decryption management 311, issuing instruction note 312, edge server monitoring and management 313, FTP server monitoring 314, client (PC/STB) monitoring 315, contents management 316, and logs management 317.

The encryption/decryption management 311 is a function to manage encryption and decryption of contents transmitted between ECD 420 in respective edge server 21a, 21b, 21c and Manager 320. In the present system the contents transmitted between the operations center 10 and edge server 21a, 21b, and 21c are secured by original encryption system, so that it prevents the digital contents or the information to be distributed from leaking to outside of the present system.

Moreover, the digital contents are distributed in the compressed format protected with an unique password each time.

Issuing instruction note 312 is a function to issue “instruction note” including commands to edge servers 21a, 21b, and 21c, and transmits it to each edge server 21a, 21b, and 21c. The instruction note contains commands which can be executed by operating system (OS) installed in edge servers 21a, 21b, and 21c. The command to edge server 21a, 21b, and 21c is, for example, to install distributed contents in the VoD server 211.

Edge server monitoring/management 313 is a function to monitor the progress of execution of the commands in the instruction note transmitted to edge servers 21a, 21b, and 21c. The status can be viewed on a monitoring screen of the management PC 11. The disk usage of each edge server 21a, 21b, and 21c or service (Daemon) information for each VoD server 211 can also be displayed on the monitoring screen. Moreover, a command, for example, “If certain daemon in the VOD server stops, reboot the VoD server.” can also be sent from the monitoring screen.

FTP server monitoring 314 is a function to monitor the status of the FTP servers 16a, . . . , 16n which are deployed in order to provide load balancing of servers on delivering digital contents or on collecting log information. Apart from load balancing, advantage of having more than one FTP servers 16a, . . . , 16n, is, in case a FTP server fails, the service can be continued by another FTP server.

Client (PC/STB) monitoring is a function to monitor client computers or/and STBs in the management database 14 at Manager 320, and if it detects troubles, perform the pre-assigned command. (for example “reboot client machine” or “update client module”).

Content management 316 is a function to be responsible for compression of the contents, and maintaining the history of delivery when only the difference between old and new versions of the digital contents are distributed. When more than certain amount of contents were not distributed to edge server 21a, 21b, 21c, contents management 316 displays alert message indicating the contents number which wasn't distributed, the name of the destination edge servers 21a, 21b, and 21c.

Log management 317 is a function to enter logs sent from the edge servers 21a and 21b and 21c via relay FTP servers 16a, . . . , 16n into database 212 in management PC 11, make it possible administrator to view the log database.

The software installed in the edge servers 21a and 21b and 21c includes edge module 400, having Edge Control Daemon (ECD) 420, main management module, transmission module 430 and Edge Control Daemon Control Daemon (ECDCD) 440. The edge module 400 can fulfill functions such as encryption/decryption transaction 411, instruction note executor 412, log collection 413, load balancing 414, automated Web page generation 415, billing system 416, and ECD control 417.

Encryption/decryption transaction 411 is a function to allow having an encrypted communication. It compares a session key generated from a public key and a private key stored in ECD 420 in the edge servers 21a, 21b, and 21c and an encrypted session key sent from the Manager 320. When both keys are authenticated, the edge server 21a, 21b, and 21c continues communication with the Manager 320. If the authentication fails, Manager 320 annuls an inquiry from the edge server 21a, 21b, and 21c and closes the communication port.

Instructions note executor 412 is a function to execute the commands indicated in instruction note sent by Manager 320.

Log collection 413 is a function to collect logs at the time specified by Manager 320, and compresses them into password-protected zip file. The compressed log file is then uploaded to relay FTP servers 16a, . . . , 16n. Upon completion of upload, log collection 413 notifies Manager 320 of the password used during compression and the end of the upload. Manager 320 downloads log files automatically from the relay FTP server on the time pre-designated by the administrator.

Load balancing 414 is a function to balance the load of VoD server 211. When the delivery servce is provided using more than one VoD servers 211, the load balancing 414 polls the number of streaming delivered and status of each VoD server 211, and then upon the next delivery request, make the least loaded VOD server 211 to perform the task.

Automated Web page generation 415 is a function to generate Web pages following an already design template with information (title, running time, casts, price and so on) stored in the database 212 in the edge servers 21a, 21b and 21c.

Billing system 416 is a function to provide various interfaces which allow an easy integration of third-party billing solution.

ECD control 417 is a module called ECDCD 440 used to upgrade ECD 420 which controls the edge servers 21a, 21b and 21c and.

[Transmission Schemes of Digital Contents Distribution System]

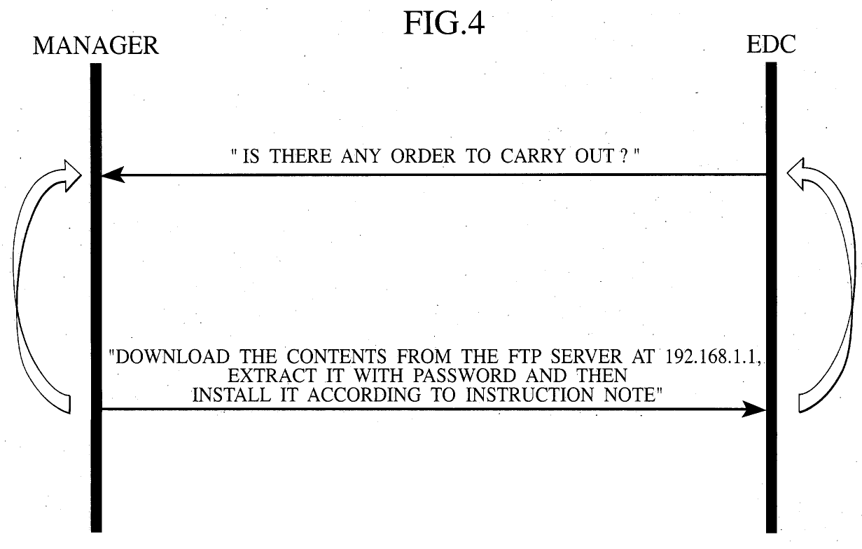

FIG. 4 shows basic communication mechanism between management PC 11 and the edge server 21a, 21b and 21c in the digital contents distribution system.

As shown in FIG. 4, ECD 420 of each edge server 21a, 21b and 21c initiates communication by inquiring to Manager 320 of management PC 11 and perform tasks according to the instructions from the Manager 320. Thus, in the present digital contents distribution system, since communication is initiated by the edge server 21a, 21b and 21c, even if fire wall and Network Address Translation (NAT) exists at the edge server 21a, 21b and 21c, communication becomes possible, and when the communication channel is ready, delivery of the digital contents and collecting logs are easily achieved.

[Functions of Digital Contents Distribution System]

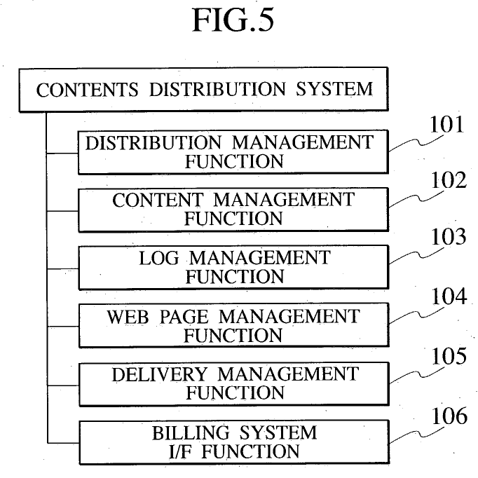

As shown in FIG. 5, the digital contents distribution system according to the present embodiment includes distribution management function 101, content management function 102, log management function 103, Web page management function 104, delivery management function 105, and billing system interface (I/F) function 106.

[Distribution Management Function]

The management PC 11 compresses the digital contents stored in the file server 13 at the operations center 10, into password-protected compressed file (Info-Zip) and uploads the compressed file to the FTP servers 16a, . . . , 16n via the management FTP server 12. When necessary, the management PC 11 attaches instruction note (instructions to install, delete, update the digital contents) to the compressed file so that it can be distributed to the edge server 21a, 21b and 21c together with contents.

When the upload from the management PC 11 is completed, the management PC 11 permits edge servers 21a, 21b and 21c downloading contents. When the management PC 11 receives the download request from edge servers 21a, 21b and 21c, it compares ID (for example, Media Access Control (MAC) address of an ethernet card) of the edge server to data stored in the management database 14 at the operations center 10. If the edge server is authenticated, the management PC 11 sends identification (for example, Internet Protocol (IP) address or the port number) of the least loaded FTP server 16a, . . . , 16n, the user ID, password and the file name to be downloaded to the authenticated edge server 21a, 21b and 21c.

The edge server 21a, 21b and 21c accesses the FTP server via the file transfer server 213 using the IP address and the port number provided by the management PC 11 and downloads the digital contents using the user ID, password, and the file name. When the download is completed, the edge server 21a, 21b and 21c analyze's the downloaded file using a predetermined checksum. If the downloaded file is incomplete such as having bit loss, the edge server 21a, 21b and 21c resends the request for download to the management PC 11.

When the edge server 21a, 21b and 21c is unable to access to the FTP server with the identification provided by the management PC 11, by sending the error information back to the management PC 11, the management PC 11 sends the identification of an alternative FTP server to the edge server 21a, 21b, and 21c.

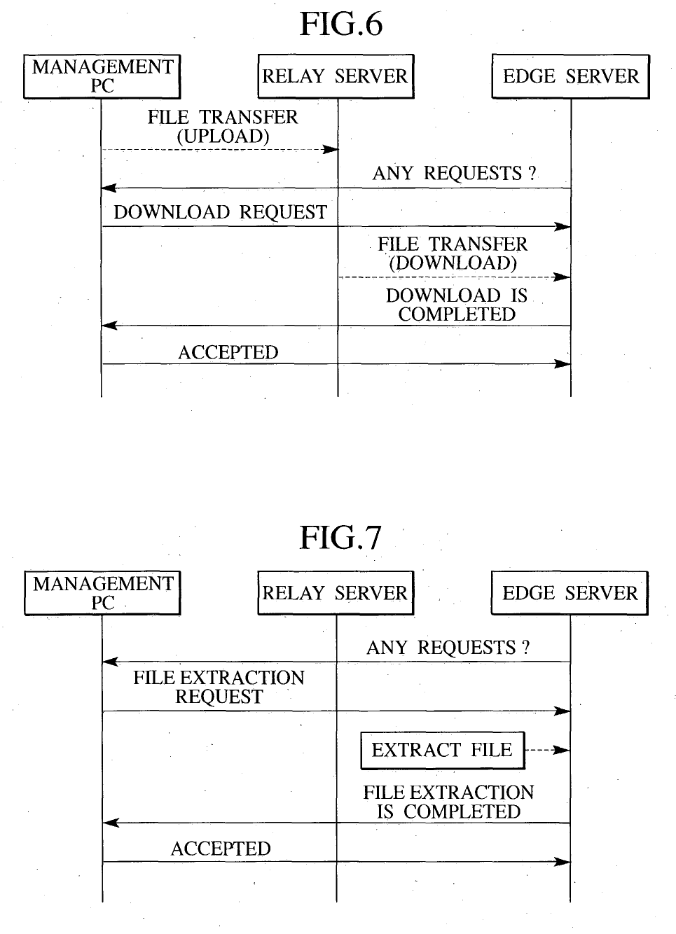

FIG. 6 shows the process of the edge server 21a, 21b and 21c downloading the digital contents uploaded by the management PC 11 to the FTP server 16a, . . . , 16n.

Moreover, distribution management function 101 contains the history management of the contents distribution. For example, when digital contents must be distributed to the edge servers 21a, 21b and 21c in a specified order, and the edge servers 21a, 21b and 21c have not yet downloaded the digital contents of the higher rank, even if the low-ranked contents are already stored in the FTP server 16a, . . . , 16n, management PC 11 controls the edge servers 21a, 21b, and 21c to download the digital contents of the higher rank first.

[Content Management Function]

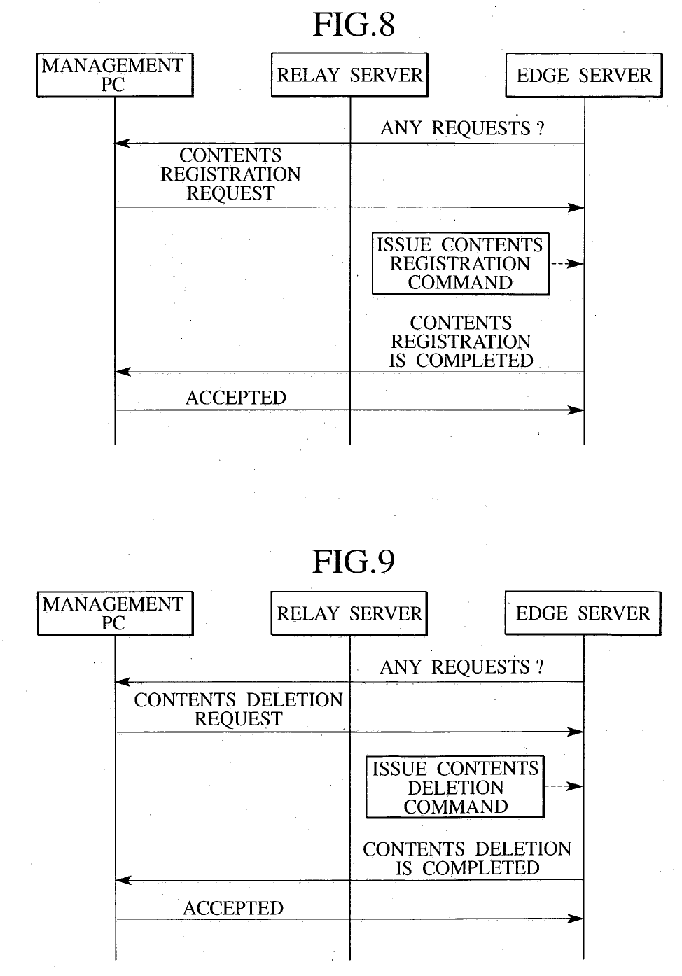

As shown in FIG. 7, the edge server 21a, 21b or 21c extracts the file downloaded from FTP server 16a, . . . , 16n to a directory specified by the management PC 11. When both the contents for streaming delivery and the instruction note are contained in the extracted files, according to the instruction text, the edge server 21a, 21b or 21c installs, deletes or updates the downloaded digital contents for streaming delivery in the VoD server 211 and the database 212 in the edge servers 21a, 21b, and 21c, or make changes on meta information for the contents installed as shown in FIG. 8 and 9.

When the above contents management request has been completed properly by the edge servers 21a, 21b, and 21c, the management PC 11 is able to delete the file which became unnecessary from the FTP server 16a, . . . , 16n, and if the management PC 11 maintains the history management of contents distribution, the management PC 11 may update the history.

[Log Management Function]

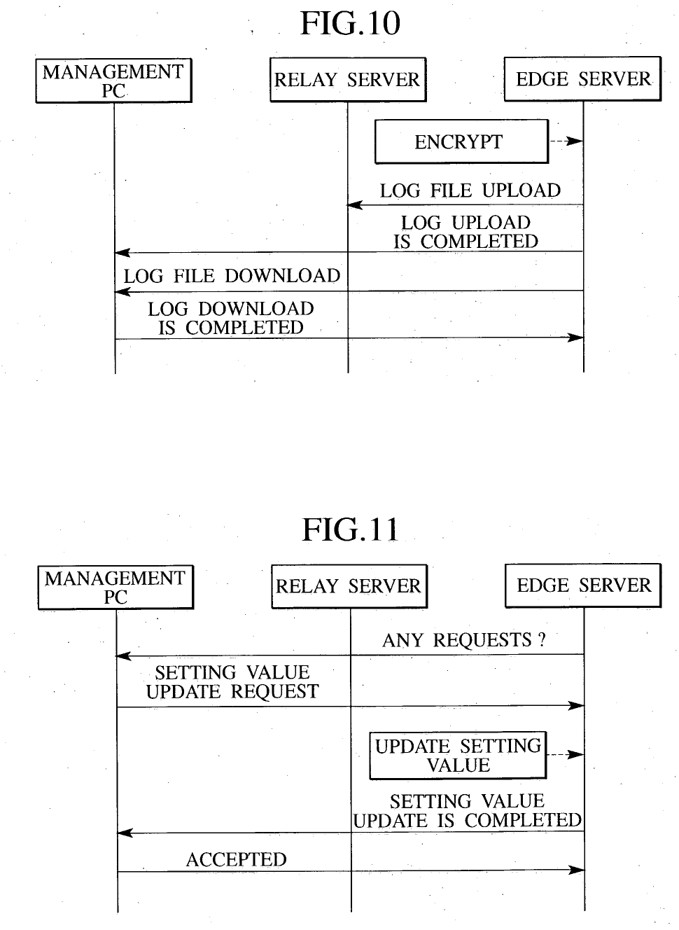

As shown in FIG. 10, the management PC 11 sends a request to collect logs to each edge server 21a, 21b, and 21c on the time pre-designed. When the request is received, each edge server 21a, 21b, and 21c collects the logs (viewing rate, the rate of a hit, error log, etc.) in each system, compresses the log files in pre-determined format, and uploads the compressed file to the FTP server 16a, . . . , 16n specified by the management PC 11.

The management PC 11 downloads the log file from FTP servers 16a, . . . , 16n, enters downloaded log files into the management database 14, and manages log data.

[Web Page Management Function]

Since the downloaded digital contents in the database 212 are managed by the content management function 102, when a user terminal (PC 221, PC 222a, . . . , 222n, STB 231, STB 233, shop terminal 24) accesses edge server 21a, 21b and 21c using Hyper Text Transfer Protocol (HTTP), Web pages suitable to the user are generated automatically acquiring information of contents which matches to the user data (such as age, hobbies, preference) from the database 212, and supplies the Web pages to the user terminal (PC 221, PC 222a, . . . , 222n, STB 231, STB 233, shop terminal 24) from Web server 215.

Moreover, in cooperation with log management function 103 the information, such as “This month's Top 10 ranking” can be displayed on the web page from Web server 215 or showing recommended contents information from Web server 215 based on the user's preference acquired from the database 212.

[Delivery Management Function]

Delivery Management function 105 includes load balancing. When more than one VoD servers 211 are controlled by each edge server 21a, 21b , and 21c, load balance function computes the frequency of access by the user terminals (PC 221, PC 222a, . . . , 222n, STB 231, STB 233, shop terminal 24) and is able to have the least loaded VoD server 211 to deliver the content.

Moreover, if a VoD server 211 stops running due to whatever the failure, delivery management function 105 is able to reboot failed VoD server 211 or take it out from the database 212.

[Billing System I/F Function]

Billing system I/F function 106 has interfaces to accommodate various third-party billing'systems.

(1) Communication with third-party solution providing billing information into a database file (for example, Comma Separated Value).

(2) Communication with third-party solution using application program interface (API) by linking with the program library of the third-party solution.

(3) Communication with the third-party solution providing a socket-based TCP/IP protocol billing system

As explained above, according to the present embodiment, it is possible to provide a system and a method for distributing digital contents, which can deliver immediately various digital contents requested by the user terminal over electronic network and to provide edge server used for the digital contents distribution system.

The details of implementation form for the present inventions has been given, however, the present inventions are not restricted to these examples. The present inventions can be implemented in other forms as well without deviating from the scope of its spirit or its characteristics.

For example, as shown in FIG. 11, the management PC 11 is able to control each edge server 21a, 21b and 21c so that set-up values in each edge server 21a, 21b and 21c may be changed by a change request from the management PC 11.

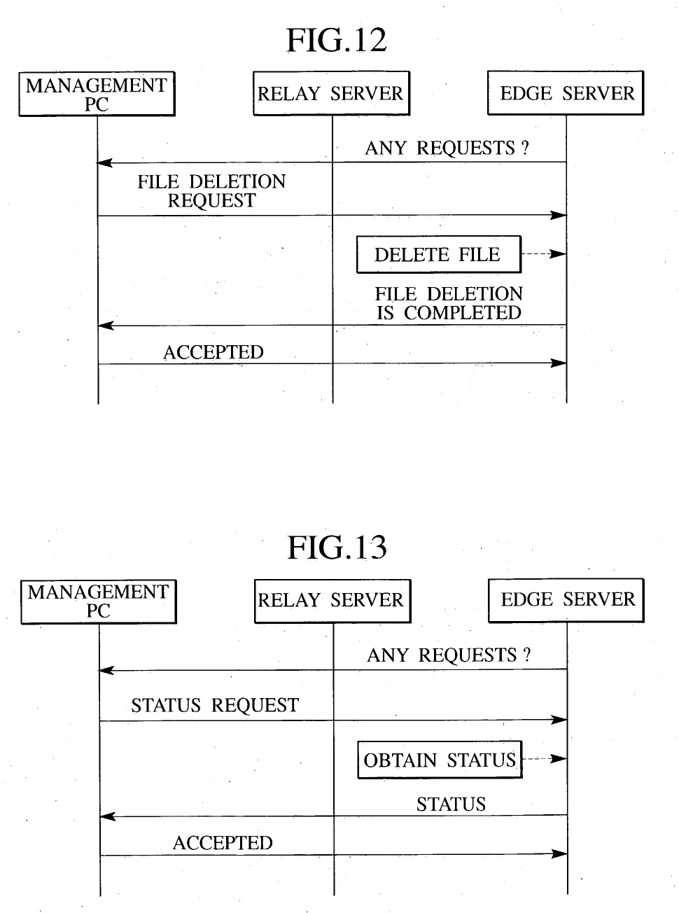

Further, as shown in FIG. 12, the management PC 11 is also able to control each edge server 21a, 21b and 21c to delete various files managed by each edge server 21a, 21b and 21c by sending a file deletion request from the management PC 11.

Furthermore, as shown in FIG. 13, the management PC 11 is able to control-each edge server 21a, 21b and 21c to report the status (for example, operation status) by sending a status request from the management PC 11 and controlling each edge server 21a, 21b and 21c based on the acquired status information.

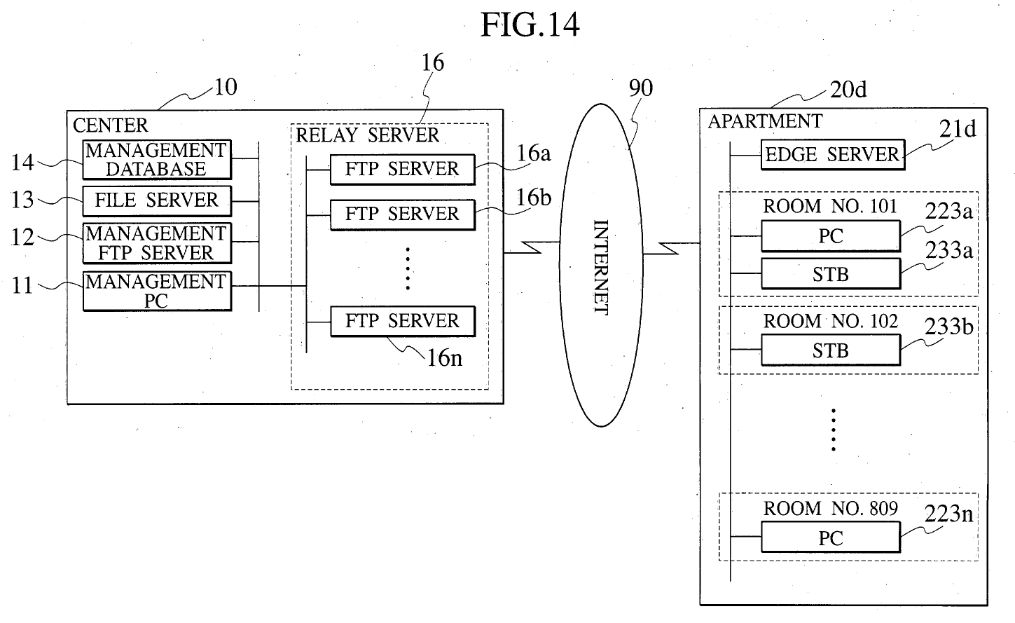

Moreover, as shown in FIG. 14, the edge server 21d is deployed in apartment 20d, and PC 223a, . . . , 223n and STB 233a, . . . , 233n are equipped in each room. The edge server 21d downloads the digital contents in advance from the FTP server 16a, . . . , 16n according to instruction from the management PC 11 at the operations center 10. And then, the edge server 21d delivers the downloaded digital contents to the user terminals (PC 223a, . . . , 223n and STB 233a, . . . , 233n) located in the same network as the edge server 21d upon receipt of a request for delivery or for download from the user terminal.

Therefore, the present invention may be implemented in other forms without deviating from its spirit or essential characteristics thereof. The present implementation is therefore to be considered in all respects as illustrative, not restrictive. The scope of the invention shall be indicated for the appended claims and not restricted by the foregoing description. All changes which come within the meaning and range of equivalency of the claims is therefore intended to be embraced therein.

This application claims benefit of priority under 35 USC §119 to Japanese Patent Application No. 2003-037345 filed on Feb. 14, 2003, the entire contents of which are incorporated by reference herein.

1. A system for distributing digital contents over electronic network, the system comprising:
a management PC configured to collect the digital contents and upload the collected digital contents to FTP servers; and
an edge server configured to download the digital contents in advance from the FTP servers according to instructions from the management PC and deliver the downloaded digital contents to a user terminal located in the same network as the edge server according to request from the user terminal.

2. The system of claim 1, wherein the edge server acquires information from the management PC to identify the least loaded FTP server where plural FTP servers are deployed and according to the above information, downloads the digital contents in advance from the least loaded FTP server.

3. The system of claim 1, wherein when contents for streaming and instruction note are contained in the digital contents, the edge server executes installation, deletion, and update of the contents for streaming to VoD servers and database of the edge server according to instruction note, and reports the result of the execution to the management PC.

4. The system of claim 2, wherein when contents for streaming and an instruction note are contained in the digital contents, the edge server executes installation, deletion, and update of the contents for streaming to VoD servers and a database of the edge'server according to instruction note, and reports the result of the execution to the management PC.

5. The system of claim 3, wherein the edge server controls the least loaded VoD server to deliver streaming contents where-plural FTP servers are deployed.

6. The system of claim 4, wherein the edge server controls the least loaded VoD server to deliver streaming contents where plural FTP servers are deployed.

7. The system of claim 1, wherein:
the edge server collects logs of delivery to the user terminals and uploads the collected logs to the FTP server specified by the management PC; and
the management PC downloads the logs uploaded to the FTP server and manages the log data.

8. The system of claim 2, wherein:
the edge server collects logs of delivery to the user terminals and uploads the collected logs to the FTP server specified by the management PC; and
the management PC downloads the logs uploaded to the FTP server and manages the log data.

9. The system of claim 3, wherein:
the edge server collects logs of delivery to the user terminals and uploads the collected logs to the FTP server specified by the management PC; and
the management PC downloads the logs uploaded to the FTP server and manages the log data.

10. The system of claim 4, wherein:
the edge server collects logs of delivery to the user terminals and uploads the collected logs to the FTP server specified by the management PC; and
the management PC downloads the logs uploaded to the FTP server and manages the log data.

11. The system of claim 5, wherein:
the edge server collects logs of delivery to the user terminals and uploads the collected logs to the FTP server specified by the management PC; and
the management PC downloads the logs uploaded to the FTP server and manages the log data.

12. The system of claim 6, wherein:
the edge server collects logs of delivery to the user terminals and uploads the collected logs to the FTP server specified by the management PC; and
the management PC downloads the logs uploaded to the FTP server and manages the log data.

13. The system of claim 3, wherein the edge server generates Web pages according to the attributes of the user with the information stored in the database, and provides the Web pages to the user terminal.

14. The system of claim 4, wherein the edge server generates Web pages according to the attributes of the user with the information stored in the database, and provides the Web pages to the user terminal.

15. A method for distributing digital contents over electronic network comprising following stages:
collecting the digital contents in a management PC and uploading the collected digital contents from the management PC to FTP servers;
downloading the digital contents in advance from the FTP servers to each edge server according to instructions from the management PC; and
delivering the downloaded digital contents to user terminals from the edge server located in-the same network as the user terminal upon receipt of a request from the user terminal.

16. An edge server used for a system for distributing digital contents over electronic network, the edge server performing:
downloading digital contents in advance from an FTP server to which a management PC uploads the digital contents collected by management PC, according to instructions from the management PC; and
delivering the downloaded digital contents to user terminal located in the same network as the edge server upon receipt of a request from the user terminal.
